(19) United States
(12) Patent Application Publication
(10) Pub. No.: US 2005/0048440 A1
(43) Pub. Date: Mar. 3, 2005

(54) Dental implants and methods for their fabrication and use

(76) Inventor: James C. Feng, Pasadena, CA (US)

Correspondence Address: JAMES C. FENG, 201 S. CATALINA AVENUE #4, PASADENA, CA, 91106, US

(21) Appl. No.: 10/649,072

(22) Filed: Aug. 26, 2003

(51) Int. Cl. A61C 8/00

(52) U.S. Cl. 433/175

(57) ABSTRACT

A dental implant for use in replacing a nonfunctional tooth includes an abutment and a base. The base of the implant has a topography this is substantially identical to the topography of the root of the nonfunctional tooth. Accordingly, the use of the implants eliminates the need for conventionally used bone drills and other traumatic preparing procedures for implant. The implant may be fabricated from a single piece of material so that the abutment and the base are unitary. In addition, the surface of the base may be treated to enhance post-implant bone growth to the base.

### FIELD OF THE INVENTION

The present invention relates to restorative dentistry and other medical procedures and to implants and prostheses associated with such procedures. More particularly, the devices and methodology of the invention enables a replica of a nonfunctional tooth or other anatomical part to be fabricated, which replica decreases trauma associated with the utilization of commercial stock prosthesis systems.

### BACKGROUND OF THE INVENTION

Dental implants are utilized in replacing nonfunctioning teeth. One example of a conventional implant is disclosed in U.S. Pat. No. 6,290,500, the entire disclosure of which is incorporated herein by references.

Conventional implants include a base that is screwed or placed into a custom bored hole in the jaw of a patient. During bone healing, the implant is embedded in the bone, with the gum tissue growing over the implant. In the case of immediate implant placement where an implant is placed at the time a nonfunctional tooth is removed, care needs to be taken to ensure that no force is applied to the implant during healing. Such force will decrease the bone's ability to heal and integrate with the implant; accordingly, stabilization during this healing period is crucial. After several months for bone integration, a second surgery is performed in which the implant receives a healing abutment for forming gum contours around the implant. An abutment with a post is then mounted onto the base by way of a screw. A prosthetic tooth or crown is then fabricated and mounted on the abutment similar to that of conventional dental crown and bridge.

Conventional implants have several morbidities associated with it. The installation of the base into the bone of the jaw is traumatic. Bone drills are used to prepare the site where the nonfunctional tooth was extracted. These bone drills and corresponding implants are inherently elongated. By drilling, there is a risk of nerve damage and sinus perforation. Further, any misplacement in the bone makes the implant difficult to restore in the proper anatomic location. In addition, fatigue in the two-part structure of the base and the abutment may lead to implant failure and breakage.

### BRIEF SUMMARY OF THE INVENTION

According to one aspect of the invention, an implant for use in replacing a nonfunctional tooth includes an abutment and a base. The base of the implant has a topography this is substantially identical to the topography or superficial morphology of the root of the nonfunctional tooth. The implant may be fabricated from a single piece of material so that the abutment and the base are unitary. In addition, the surface of the base may be treated to enhance post-implant bone or ligament growth to the base.

In contrast to conventional devices, the implants of the invention eliminate the need for conventionally used bone drills and other traumatic site-preparation procedures. Other advantages include ease of use and minimal necessary parts and components. Further, in embodiments where the implant is unitary, there is no screw between the abutment and the base to loosen or break. In addition, the implants and methodology of the invention minimize or eliminate the need for bone grafting surgeries such as sinus lift procedures.

Still other advantages include the ability to shape or prepare the abutment similar to conventional crown and bridge preparations and the ability to custom make a replicate implant for each patient to ensure fit, adaptation, and patient acceptance. Further, the dental papilla is preserved which is necessary for esthetics of anterior restorations. The methodology ensures that the implant placed in a proper position, thereby minimizing guessing or necessary use of surgical guides or stents. Trauma is further mitigated in that the extraction and implantation may be done during a single-stage surgery.

The principles of the invention are not limited to uses in tooth replacement procedures but are applicable to any medical procedure in which it is advantageous to utilize a custom-made prosthesis that resembles or essentially replicates a nonfunctional anatomical part.

Other features and advantages of the present invention will become apparent to those skilled in the art from a consideration of the following detailed description taken in conjunction with the accompanying drawings.

### BRIEF DESCRIPTION OF THE SEVERAL VIEWS OF THE DRAWINGS

FIG. 1 illustrates an implant according to a number of embodiments of the invention;

FIG. 2 illustrates a nonfunctional tooth;

FIG. 3 illustrates anatomical features of a tooth;

FIG. 4 illustrates an implant with a crown;

FIG. 5 illustrates methodology in fabricating an implant of the invention;

FIG. 6 illustrates methodology in fabricating and implanting an implant of the invention;

FIG. 6A illustrates a digital-imaging process of a mouth of a patient;

FIG. 6B illustrated a three-dimensional image of a jaw;

FIG. 7 illustrates an implant with a base having a treated surface;

FIG. 8 illustrates an implant with a base having holes bored therethrough;

FIG. 9 is a cross-sectional view of a nonfunctional tooth being removed;

FIG. 10 is a cross-sectional view of an implant being implanted;

FIG. 11 schematically illustrates plural stabilization devices;

FIG. 12 is a cross-sectional view illustrating discontinuities in a surface of an implant;

FIG. 13 illustrates an implant of the invention for use with a removable prosthesis according to a number of embodiments; and

FIG. 14 illustrates a non-unitary implant according to still other embodiments of the invention.

### DETAILED DESCRIPTION OF THE INVENTION

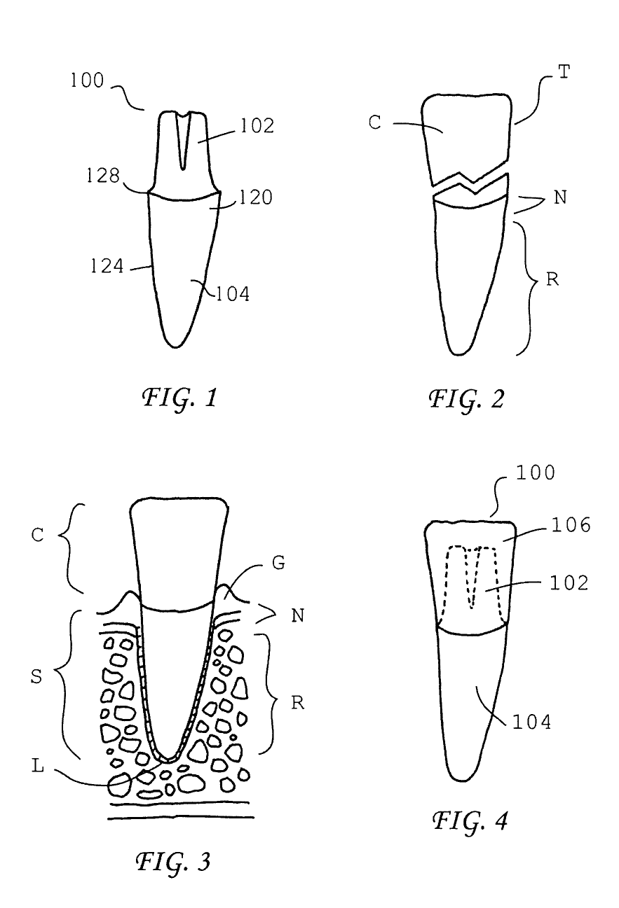

Referring more particularly to the drawings, an implant 100 for use in replacing a nonfunctional tooth is illustrated in FIG. 1. A nonfunctional tooth T is illustrated in FIG. 2 and has a root R with an anatomical topography. With additional reference to FIG. 3, a tooth T also has a neck N, and a crown C. For the purposes of this description, a subgingival portion S of a tooth T is defined as the portion of the tooth that extends below a surface of the gums, or gingival G. The subgingival portion S includes the root R and generally includes at least a portion of the neck N. The term “topography” is defined herein as a description of the surface morphology of an anatomical part, such as the root R, the neck N, and the subgingival portion S of a tooth T.

According to the invention, the implant 100 includes an abutment 102 and a base 104. As know in the art, the abutment 102 of an implant is designed to receive an artificial crown 106, as shown in FIG. 4. As shown in FIGS. 1 and 2 and in contrast to conventional implants, the base 104 of the implant 100 has a topography this is substantially identical to that of the root R of the nonfunctional tooth T. In a number of embodiments, the implant 100 is fabricated from a single piece of biocompatible material, for example, titanium, so that the abutment 102 and the base 104 are unitary.

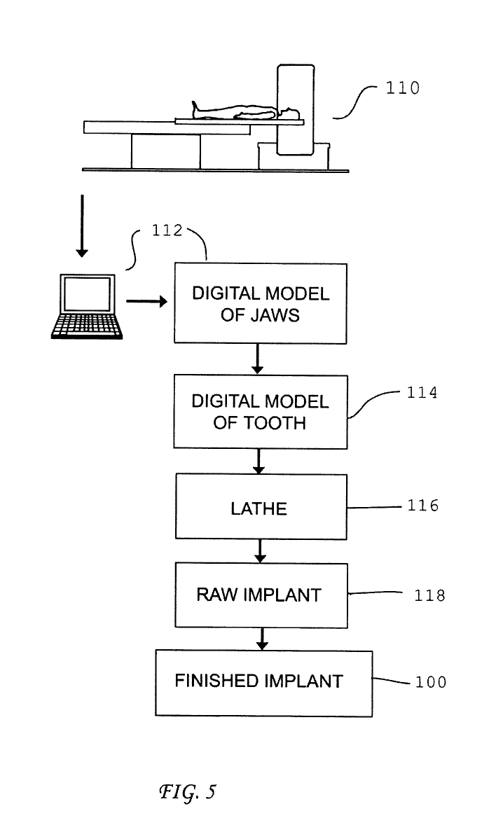

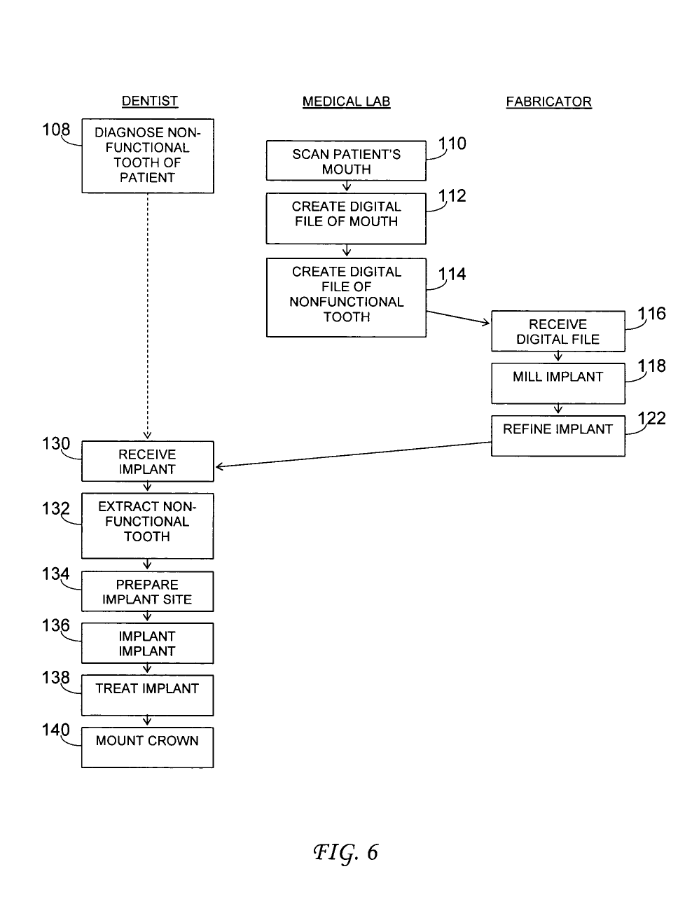

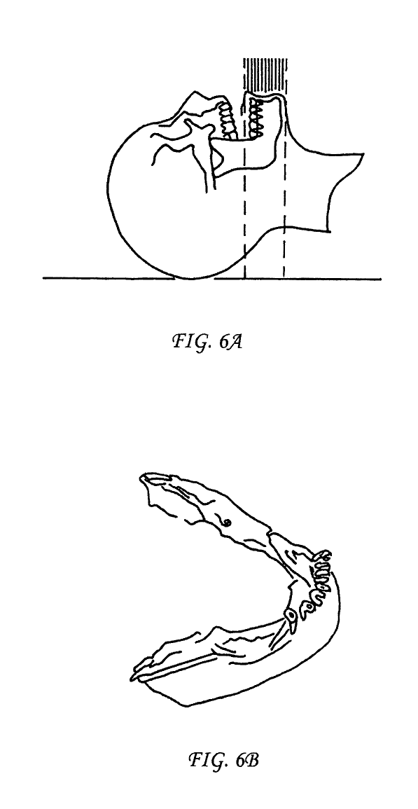

With additional reference to FIGS. 5 and 6, when a dentist diagnoses a patient with a nonfunctional tooth (step 108) and determines that the nonfunctional tooth needs to be replaced, the patient is sent to a medical lab where the mouth of the patient is scanned (step 110), which is illustrated in FIG. 6A. The scanning process may be any three-dimensional imaging process known in the art that is able to produce a digitized image of the topography of the nonfunctional tooth, such as computer-aided tomography (which is shown in FIG. 6A), magnetic resonance imaging (MRI), and so on. Upon scanning, a digitized file of the mouth or jaw is created (step 112), a three-dimensional representation of which is shown in FIG. 6B.

According to some of the embodiments, the portion of the digitized file of the mouth relating to the nonfunctional tooth may then be extrapolated by computer software, thereby yielding a digitized file containing data essentially of the nonfunctional tooth (step 114).

This digital file containing data relating to the implant further constructs the abutment 102 portion of the implant via software in the same way a dentist would prepare the tooth in the patient's mouth to receive a crown.

The digital file containing data relating to the anatomical topography of the nonfunctional tooth may then be sent to a fabricator (step 116). The data from the digital file may then be utilized by an appropriate machine, such as a computer-aided manufacturing (CAM) lathe, to mill an implant with a base that has substantially identical topography as that of the nonfunctional tooth (step 118).

In additional to substantially identical topographies between the root R and the base 104, in a number of embodiments, the milled implant 100 may also include substantially identical topographies between the neck N and an upper portion 120 of the base 102 (see FIG. 1). In other embodiments, the base 104 of the implant 100 has a substantially identical topography as that of the subgingival portion S of the nonfunctional tooth T.

As mentioned above, in some of the embodiments, the implant 100 may be fabricated such that the abutment 102 and the base 104 are unitary. This may be accomplished by milling the implant 100 from a single piece of material.

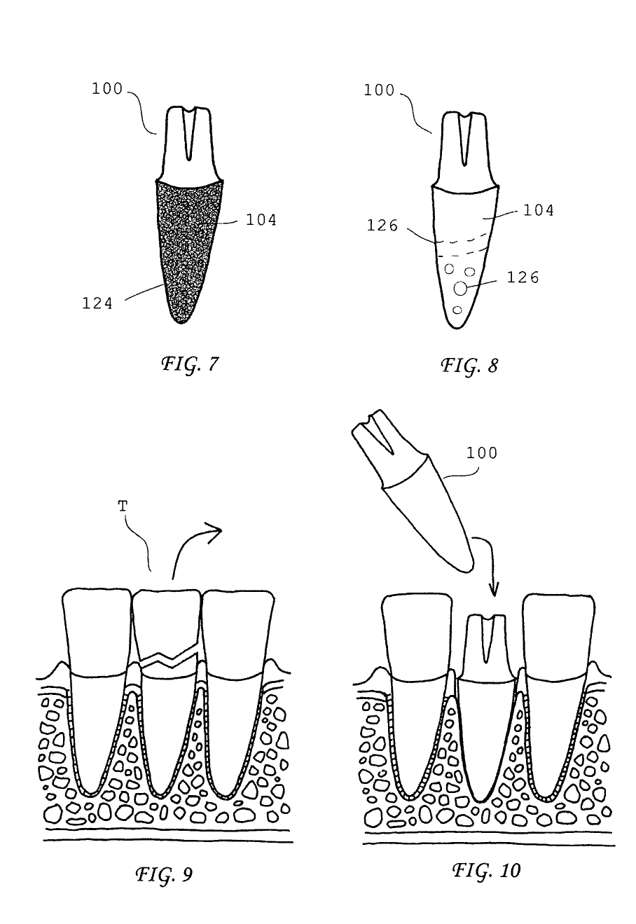

After milling the implant 100, the fabricator may further refine the implant 100 (step 122). For example, a surface 124 of the base 104 (see FIG. 1) may be treated to enhance the implantation of the implant 100 in the site where the nonfunctional tooth was extracted, for example, by facilitating the growth of bone to the base 104. Examples of the surface treatment may include processes that increase the surface area as shown in FIG. 7, thereby enhancing the ability of the bone of the jaw to “adhere” to the implant. For example, the base 104 may be etched or sand blasted. Alternatively, the base 104 may be coated with various material to enhance bone or ligamental integration. An example of such a material is hydroxyapatite. Further, as shown in FIG. 8, one or more holes 126 may be bore into or through the base 104 of the implant 100, which holes are illustrated by dashed lines.

Further refining of the implant 100 may include machining a collar 128 between the abutment 102 and the base 104 (see FIG. 1) as to enhance gingival attachment to the implant. When the finished implant 100 is completed, the fabricator may sterilize and package the implant 100 for shipment to the dentist.

Upon receipt of the implant 100 (step 130), the dentist may then extract the nonfunctional tooth (step 132) as shown in FIG. 9, thereby leaving an extraction site. The extraction of the nonfunctional tooth should be accomplished as atraumatic as possible. The dentist may treat the extraction site (step 134), such as removing the periodontal ligament L (see FIG. 3). As shown in FIG. 10, the dentist may then place the implant 100 into the extraction site (step 136) For example, the dentist may gently tap the implant 100 into place.

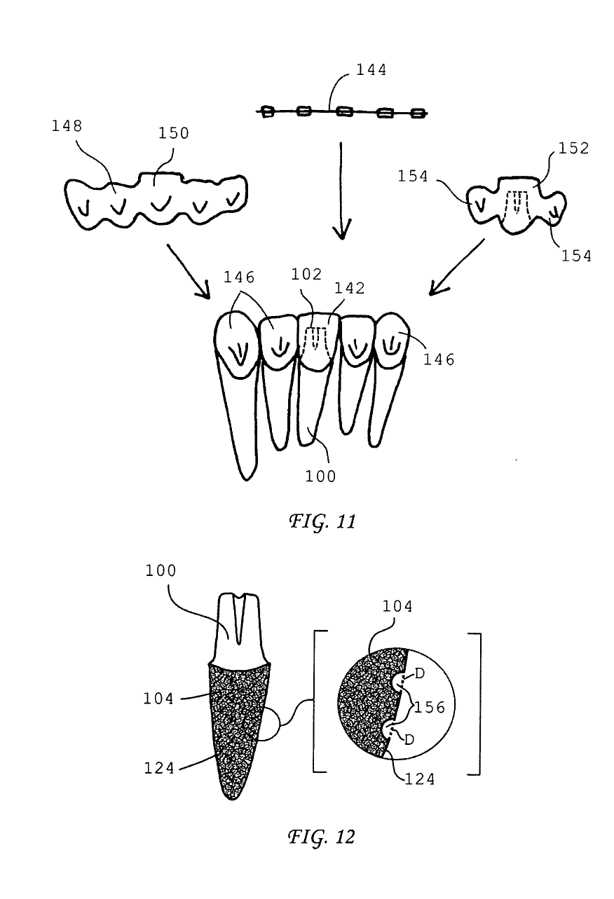

The implant 100 may then be stabilized and temporized. With reference to FIG. 11, the implant 100 may be stabilized by mounting a temporary crown 141 and then splinting the implant 100 with the crown 142 with a wire 144 connected to adjacent teeth 146. Alternatively, a custom-made lingual metal plate 148 may be fitted and cemented to the lingual side of the implant 100 with temporary crown 142 and the adjacent teeth 146. The lingual plate 148 may include an implant protrusion 150 that protects the biting or incisal edge of the implant 100 by extending slightly above a top surface of the temporary crown 142.

Still alternatively, the implant 100 may be stabilized by fabricating a loose-fitting temporary crown 152 with a pair of metal wings 154. The temporary crown 152 is configured to adapt precisely to the adjacent teeth 146 and is cemented thereto. In contrast to a conventional Maryland bridge, the temporary crown 52 fits over the abutment 102 of the implant 100 but is not in intimate contact with the abutment 102, thereby preventing movement of the implant 100.

When integration of body elements (bone or ligament) with the implant element is complete or ready, any temporary crown may be removed, and a permanent crown 106 (see FIG. 4) may be fabricated and installed on the abutment 102 of the implant 100 (step 140).

For the purposes of this description, the term “substantially identical” has been used to describe and relate the topography of the base 104 of the implant 100 with that of the nonfunctional tooth T. Insofar as accurate as the scanning process (step 110) is and as accurate as the data are contained in the digital file (step 114) in representing the anatomical topography of the nonfunctional tooth T, there may be minor discrepancies between the topographies of the base of the implant and the root of the tooth. Such discrepancies do not depart from the scope and spirit of the invention in which an implant is used to replace a nonfunctional tooth as atraumatic as possible. In addition, in some of the embodiments, the base 104 may have a topography that is substantially identical to the anatomical topography of a portion of the root R and not the entire root itself. Furthermore, with reference to FIG. 12, in embodiments where the surface 124 of the base 104 is treated to enhance bone growth thereto, for example, with the formation of discontinuities 156 resulting from etching, the term “substantially identical” is used to indicate that the topography of the base 104 absent the discontinuities 156 (as indicated by dashed lines D) is substantially the same as or substantially replicates the anatomical topography of the root R.

In some of the embodiments in actual practice, the topography of the base of the implant may not substantially match or replicate the topography of the nonfunctional tooth. In such embodiments, the implant still satisfactorily functions as an atraumatic replacement for a nonfunctional tooth. Accordingly, in a number of embodiments, the implant 100 has a base 104 with a topography that generally represents the root R of the nonfunctional tooth T to be replaced which is shown in FIGS. 1 and 2. Further, the implant 100 of the invention is implanted by inserting and gently tapping or press fit, not by screwing or rotation in the case of the bores of conventional implants. In addition, the implant 100 does not require an abutment to be attached subsequent to the implantation of the base.

Referencing FIG. 13, in a number of embodiments an implant 200 of the invention with a base 202 and an abutment 204 may be configured to retain a removable prosthesis 206. More specifically, analogous to the description above, the implant 200 may be fabricated so that the base 202 has a topography that is substantially identical to that of a root R. Rather than being configured to receive a permanent crown as described above, in some of the embodiments the abutment 204 may be configured to releasable engage with a prosthesis. For example, the abutment 204 may include a post 208 with an enlarged head 210. The removable prosthesis 206 may include a socket 212 that is configured to complement the shape of the post 208. Accordingly, the prosthesis 206 may be urged onto the abutment 204 for engagement. As shown in FIG. 13, a plurality of implants 204 may be implanted in a patient depending upon the configuration of the prosthesis.

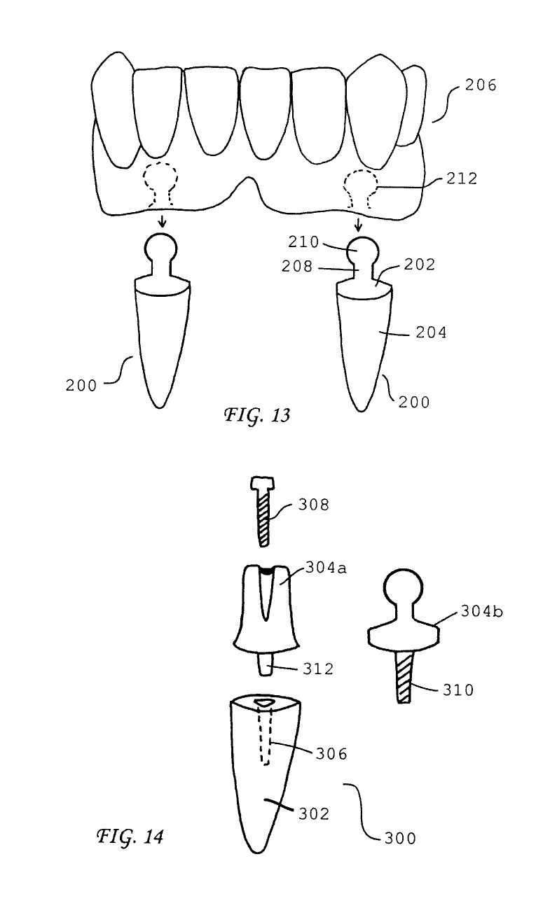

In other embodiments of the invention as shown in FIG. 14, an implant 300 may include a base 302 and an abutment 304. Analogous to the foregoing description, the implant 300 may be fabricated so that the base 302 has a topography that is substantially replicates that of a root R. Rather than having a unitary construction as described above, the implant 300 has a non-unitary construction. More specifically, the abutment 304 is a separate element. As shown, abutment 304a is configured to receive a permanent crown, and abutment 304b is configured to releasably engage with a prosthesis.

To integrate the implant 300, the base 302 may include a threaded hole 306 for receiving and engaging with a screw 308 of abutment 304a or a threaded post 310 of abutment 304b. The permanent-crown abutment 304a may include a through hole (not shown) for receiving the screw 308. In addition, the hole 306 may be configured to receive a neck 312 of abutment 304a.

The principles of the invention may be applied to a scenario in which a tooth is not present, but rather there is a prepared extraction site. In these embodiments, the extraction site where an implant is to be implanted may be scanned to yield a digital file containing data representing the anatomical topography of the extraction site. An implant may then be milled with a base having a topography that complements the topography of the extraction site for atraumatic implantation in the extraction site.

Those skilled in the art will understand that the preceding embodiments of the present invention provide the foundation for numerous alternatives and modifications thereto. For example, the principles of the invention are not limited to uses in tooth replacement procedures but are applicable to any medical procedure in which it is advantageous to utilize a custom-made prosthesis that resembles or essentially replicates a nonfunctional anatomical part. These other modifications are also within the scope of the present invention. Accordingly, the present invention is not limited to that precisely as shown and described in the present invention.

1. An implant for use in replacing a nonfunctional tooth, the nonfunctional tooth having a root with an anatomical topography, the implant comprising:
an abutment; and
a base having a topography this is substantially identical to that of the root of the nonfunctional tooth.

2. The implant of claim 1 wherein the abutment and the base are fabricated from a single piece of material.

3. The implant of claim 1 wherein the abutment and the base are unitary.

4. The implant of claim 1 wherein a surface of the base is etched.

5. The implant of claim 1 wherein a surface of the base is sand blasted.

6. The implant of claim 1 wherein a surface of the base is coated with an integration-enhancing material.

7. The implant of claim 1 wherein the abutment is configured to receive a removable prosthesis.

8. The implant of claim 1 wherein the abutment and the base are non-unitary.

9. The implant of claim 8 wherein the abutment is threadingly engaged to the base.

10. The implant of claim 9 wherein the base includes a threaded hole and the abutment includes a screw for engaging with the threaded hole.

11. The implant of claim 1 further comprising a collar disposed between the abutment and the base.

12. A method for making a implant for a nonfunctional tooth, the implant having a base and an abutment, the nonfunctional tooth having a root with an anatomical topography, the method comprising:
receiving data indicative of the topography of at least the subgingival portion of the nonfunctional tooth; and
utilizing the data to mill an implant with a base having a topography that is substantially identical to that of the root of the nonfunctional tooth.

13. The method of claim 12 wherein the implant is milled from a single piece of material.

14. The method of claim 12 further comprising refining the implant.

15. The method of claim 14 wherein the refining step comprises treating the surface of the base of the implant.

16. The method of claim 15 wherein the treating step comprises etching.

17. The method of claim 15 wherein the treating step comprises sand blasting.

18. The method of claim 15 wherein the treating step comprises hydroxyapatite coating the base.

19. The method of claim 15 wherein the treating step comprises modifying the surface for enhancing integration with bone.

20. The method of claim 14 wherein the refining step comprises boring at least one hole into the base of the implant.

21. The method of claim 14 wherein the refining step comprising machining a collar between the base and the abutment.

22. The method of claim 12 further comprising sterilizing the implant.

23. The method of claim 12 further comprising packaging the implant.

24. A method for replacing a nonfunctional tooth, the nonfunctional tooth having a root with an anatomical topography, the method comprising:
receiving an implant having a base and an abutment, the base having a topography that is substantially identical to that of the root;
extracting the nonfunctional tooth, thereby leaving a site;
implanting the implant in the site

25. The method of claim 24 further comprising preparing the site prior to implanting.

26. The method for claim 25 wherein the preparing step comprises removing ligament fibers.

27. The method of claim 24 further comprising treating the implant after implanting.

28. The method of claim 27 wherein the treating step comprises temporizing the implant.

29. The method of claim 27 wherein the treating step comprises stabilizing the implant.

30. A method of claim 29 wherein the stabilizing step comprises stabilizing the implant with wire.

31. A method of claim 29 wherein the stabilizing step comprises stabilizing the implant with a lingual plate.

32. A method of claim 29 wherein the stabilizing step comprises stabilizing the implant with a temporary crown.

33. The method of claim 24 further comprising installing a permanent crown on the abutment.
